(19) United States
(12) Patent Application Publication
(10) Pub. No.: US 2010/0022253 A1
(43) Pub. Date: Jan. 28, 2010

(54) Mobile device

(75) Inventor: Jonas Magnusson, Malmo (SE)

Correspondence Address: EDWARDS ANGELL PALMER & DODGE LLP, P.O. BOX 55874, BOSTON, MA, 02205, US

(73) Assignee: Sony Ericsson Mobile Communications AB, Lund (SE)

(21) Appl. No.: 12/220,278

(22) Filed: Jul. 23, 2008

(51) Int. Cl. H04Q 7/20; H04M 1/00

(52) U.S. Cl. 455/456.3; 455/550.1

(57) ABSTRACT

A mobile device is provided which in an embodiment comprises a circuit to obtain position information, a circuit to obtain commercial information, a circuit to detect patterns based on said position information and said commercial information and a circuit to convey information to a user based on said patterns. A corresponding method is also provided.

### FIELD OF THE INVENTION

The present invention relates mobile devices and corresponding methods

### BACKGROUND OF THE INVENTION

Mobile Devices are convenience frequently used nowadays. Examples for such mobile devices are cellular phones, personal digital assistants, mobile navigation systems, laptop computers, just to name a few. While at the beginning of the development of such mobile devices each type of device had its specific function, for example a telephone function in cellular phones or a time keeping or scheduling function in personal digital assistants, nowadays mobile devices are often multifunctional. For example, besides providing access to a telephone network, current cellular phones incorporate cameras, schedulers, alarm clocks, music players or other functionalities which are not immediately related with the telephone functionality.

Therefore, there is a continous need to provide additional functions to mobile devices.

### SUMMARY OF THE INVENTION

According to an embodiment, a mobile device is provided, comprising:
a position detecting circuit configured to obtain position information indicative of a position of said mobile device,
an information obtaining circuit configured to obtain commercial information related to said position,
a pattern detecting circuit configured to detect patterns based on said position information and said commercial information, and
an information conveying circuit configured to convey information to a user of the mobile device based on said detected patterns.

Said position detecting circuit comprises a satellite receiver configured to receive signals from a satellite navigation system.

Said information obtaining circuit may for example comprise a telecommunication circuit to obtain said commercial information from a remote database.

Said commercial information obtaining circuit in another embodiment may for example comprise a database, said database comprising said commercial information.

In an embodiment, said commercial information comprises information regarding a business chosen from the group comprising a restaurant, a bar, a shopping facility, a night club, a cinema, a theater, a coffee shop and a sport facility,
wherein a distance between said business and said position is smaller than a predetermined distance.

Said pattern detecting circuit may for example be configured to detect patterns indicating that the mobile device is regularly located at a specific type of business around specific times.

Said information conveying circuit may for example be configured to convey information regarding the specific type of business at or near said specific time.

In an embodiment, at least two circuits of said position detecting circuit, information obtaining circuit, pattern detecting circuit and information conveying circuit are implemented as a common circuit.

The mobile device may for example be chosen from the group comprising a cellular phone, a navigation system, a personal digital assistant, a smartphone, a laptop computer and a portable music player.

In an embodiment said mobile device further comprises a storage,
wherein the mobile device is configured to store at least one item chosen from the group comprising said position, said commercial information and said pattern, and to delete said stored item after a predetermined time.

In another embodiment, a method is provided, comprising: obtaining position information indicative of a position of a mobile device,
obtaining commercial information related to said position, detecting at least one pattern based on said position information and said commercial information, and
conveying information to a user of the mobile device based on said detected patterns.

Said obtaining of position information may for example comprise receiving signals from a satellite navigation system.

Said obtaining of commercial information may for example comprise obtaining said commercial information from a remote database.

In an embodiment, said commercial information comprises information regarding a business chosen from the group comprising a restaurant, a bar, a shopping facility, a night club, a cinema, a theater and a sport facility,
wherein a distance between said business and said position is smaller than a predetermined distance.

Said pattern detecting may for example comprise detecting at least one pattern indicating that the mobile device is regularly located at a specific type of business around specific times.

### BRIEF DESCRIPTION OF THE DRAWINGS

FIG. 1 shows a block diagram of a mobile device according to an embodiment, and

FIG. 2 shows a flow diagram of a method according to an embodiment.

### DETAILED DESCRIPTION OF THE INVENTION

In the following, embodiments of the present invention will be described in detail. It is to be understood that the following description is given only for the purpose of illustration and is not to be taken in a limiting sense. The scope of the invention is not intended to be limited by the embodiments described hereinafter, but is intended to be limited only by the appended claims and equivalents thereof.

It is also to be understood that in the following description of embodiments, any direct connection or coupling, i.e. any connection or coupling without intervening elements, between functional blocks, devices, components, circuit elements or other physical or functional units shown in the drawings described herein could also be implemented by an indirect connection or coupling, i.e. a connection or coupling comprising one or more additional intervening elements. Furthermore, it should be appreciated that representing different blocks or using performing different functions in the drawings is not to be construed as indicating that these blocks or units necessarily have to be implemented in physically separated circuits. In contrast, unless noted to the contrary, functional blocks or units shown in the drawings may be implemented as separate circuits in some embodiments, but may also be fully or partially implemented in a common circuit in other embodiments.

It is further to be noted that describing an embodiment which comprises a plurality of elements is not to be construed as indicating that all these elements are necessary for practicing the invention. Instead, in other embodiments, fewer elements and/or alternative elements may be present.

It is to be understood that features of the various embodiments described herein may be combined with each other unless specifically noted otherwise.

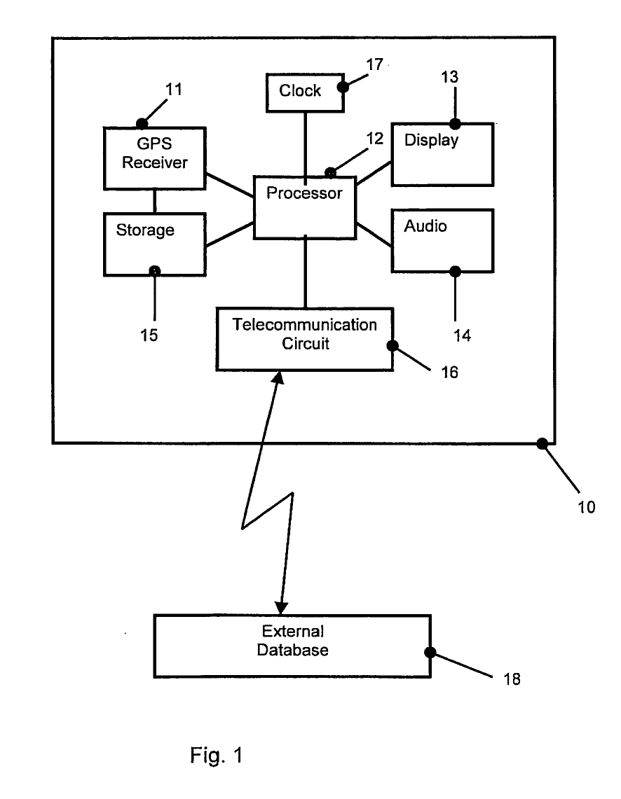

Turning now to the figures, in FIG. 1 a block diagram of a mobile device 10 according to an embodiment of the present invention is shown. Mobile device 10 may for example be a cellular phone, a personal digital assistant, a laptop computer, a mobile navigation system, a smartphone, a portable music player, a camera, combinations thereof or any other form of mobile, i.e. portable electronic device.

Mobile device 10 of the embodiment of FIG. 1 comprises a GPS receiver 11 which is operable to receive position data from GPS (Global Positioning System) satellites. With the position data received from these satellites, GPS receiver 11 and/or a processor 11 coupled to a GPS receiver 11 may determine the position of mobile device 10. Additionally, from the data received by GPS receiver 11, in an embodiment the local time of mobile device 10 may be obtained. Additionally or alternatively, a clock 17 may be provided which indicates a time and which may be user configurable to also indicate the local time of mobile device 10, i.e. the time of the time zone mobile device 10 is located in.

GPS receiver 11 may in an embodiment send the data received to processor 12. In another embodiment, additionally or alternatively GPS receiver 11 may store the received position data in a storage 15 to be accessed by processor 12 later.

Storage 15 may be any kind of suitable storage for storing data, for example a flash memory based storage, hard disc based storage or other kinds of non-volatile or volatile storage.

In some embodiments, mobile device 10 further comprises a display 13 and/or an audio unit 14. Display 13 in an embodiment may be used to display messages to a user. Audio unit 14 in an embodiment may be used to reproduce audio messages to be received by a user of mobile device 10.

Mobile device 10 may further comprise a telecommunication circuit 16 for communicating with other devices. In an embodiment, telecommunication circuit 16 may be used to communicate with an external database containing commercial information, for example information regarding businesses like restaurants, bars, shops, cinemas, night clubs, theaters, sport facilities, coffee shops or other facilities or businesses, for example locations of such businesses, programs or menus of such businesses and/or prices of such businesses.

It should be noted that mobile device 10 may comprise further units or elements for performing further functions. For example, in case mobile device 10 is a cellular phone, mobile device 10 may comprise further elements commonly used in cellular phones like a sim card reader, a keypad for entering for example telephone numbers or circuitry for reproducing music. In embodiments, the elements shown in FIG. 1 may be elements dedicated to performing the functions which will be described below in more detail. In other embodiments, the elements shown in FIG. 1 are general purpose elements which additionally may be used for other functions of mobile device 10. For example, GPS receiver 11 may be used for a navigation function, telecommunication circuit 16 may be used for transmitting voice or other data, for example in case mobile device 10 is a cellular phone, audio unit 14 may be used for reproducing music or ring tones of a cellular phone, or processor 12 may be a processor generally coordinating the function of mobile device 10.

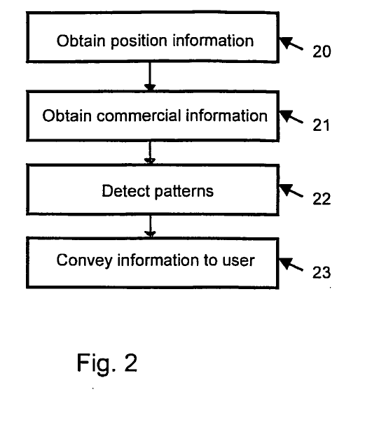

In an embodiment, processor 12 controls the elements of mobile device 10 represented in FIG. 1 to provide information to a user of the mobile device 10 regarding businesses or commercial services which may be of interest to her/him at certain times. An embodiment of a method to achieve this which may be implemented in mobile device 10 will now be explained with reference to FIG. 2. Such a method may for example be implemented by instructions for processor 12 stored in storage 15 in the embodiment of FIG. 1 which cause processor 12 to control mobile device 10 to perform the method which will be explained with reference to FIG. 2.

In FIG. 2, at 20 position information of a mobile device like mobile device 10 of FIG. 1 is obtained. This position information may for example be obtained using a GPS receiver like GPS receiver 11 of FIG. 1. Another embodiment, position information may be obtained using other data, for example data received from telecommunication base stations of a mobile telecommunication network, which data may be received by a telecommunication circuit of the mobile device like telecommunication circuit 16. The position information is indicative of the position of the mobile device using any suitable coordinate system like for example a WGS (World Geodetic System) like WGS84.

At 21, commercial information corresponding to the position information is obtained in the embodiment of FIG. 2. In other words, at 21 it is checked whether the position obtained corresponds to some business, which for example then indicates that the mobile device and therefore the user of the device is in a restaurant, a bar, a cinema, a night club, a theater, a sports facility or any other commercial or leisure facility.

This information as already explained with reference to FIG. 1 may be obtained from an external database using a telecommunication connection via any network, for example a mobile network, the internet, a local network or a combination thereof. An example for such an external database is Google™ mobile maps, which is a service accessible by mobile devices like cellular phones and where information regarding business facilities at a specific location may be obtained.

In an embodiment, the position information together with the correspondingly obtained commercial information is stored in a storage like storage 15 of mobile device 10 of the embodiment of FIG. 1.

At 22, one or more patterns are detected in the obtained position information and commercial information. To detect such patterns, time information for example obtained together with the position information at 20 or supplied by a clock like clock 17 may be taken into account.

In an embodiment, a pattern is detected when the position information and the commercial information indicates that the user of the mobile device is at least in most cases in a business of a certain type at certain times. For example, such a pattern may be detected by evaluating the position information for periods where the position stays at least approximately, i.e. within a predetermined radius, constant for a predetermined period of time, for example constant within 20 or 30 meters (or any other distance) for at least 15 minutes, 30 minutes, one hour or any other suitable time.

An example for a detected pattern may be that the mobile device and therefore the user is in a restaurant or bar almost all weekdays some time between 12 pm and 1 pm indicating that the user usually has lunch on weekdays between 12 pm and 1 pm. Another pattern may indicate that the user regularly goes to the cinema or to a sport facility on a certain weekday at a certain time. Still another pattern may indicate that the user goes to a coffee shop, a bar, a night club or a hotel at certain times.

The one or more detected patterns in an embodiment are then stored, for example in storage 15 of the embodiment of FIG. 1.

Based on the detected pattern or patterns, at 23 information is conveyed to a user of the mobile electronic device, for example by displaying the information on a display like display 13 of FIG. 1 or by outputting audio messages, for example using audio unit 14 of the embodiment of FIG. 1. The way the information is conveyed, i.e. using a display, using an audio unit or using other means like a vibration alert may be user configurable, i.e. in an embodiment the user may select the way the information is conveyed to him.

In an embodiment, the conveying of information comprises informing the user of businesses corresponding to the habit of the user represented by at least one of the detected patterns.

For example, in case as mentioned above the pattern indicates that the user has lunch almost all weekdays some time between 12 pm and 1 pm, in an embodiment shortly before this time, for example at or about 11:45 am, a reminder is displayed on a display of the mobile device that it is time for lunch. In an embodiment, together with the reminder information regarding one or more lunch restaurants may be displayed which may be obtained from an external database like google mobile maps. For example, the closest lunch restaurant or all lunch restaurants within a predetermined distance, for example within 500 meters, may be displayed. In an embodiment, additional information regarding such restaurants may be displayed, for example directions, pricing, opening hours or menu, wherein such additional information may be conveyed dependent on which information is obtainable from a data base used like Google™ mobile networks. As another example, in case the pattern indicates that the user regularly, for example at least once every four weeks, goes to the cinema on a specific day of the week, in the afternoon of this day programs of cinemas and/or the location of the closest cinemas compared with the actual position of the mobile device may be displayed. Similar displays may be made when the pattern indicates a likely visit of sport facilities, a bar or other facilities like the ones mentioned above.

Furthermore, using for example Google™ mobile maps, a map may be displayed showing the way to the facility in question.

In an embodiment, the actions described with reference to FIG. 2 are performed continuously, such that the position information and commercial information is continuously obtained and patterns are detected. In this way, new habits of a user, which may arise from a change of habits of the same user or by a change of user, may be detected. In some embodiments, the patterns detected are assigned with a limited time to live, for example one week, one month, a predetermined number of months or one year, such that in case the pattern is not detected anew, it is deleted from a corresponding storage. In still another embodiment, the mobile device may be used by different users which for example log into the device with different user names, and the patterns are stored and evaluated separately for each user.

The above-described embodiments are only examples for the implementation of the present invention, and numerous changes and modifications are possible in other embodiments without departing from the scope of the present invention. Some possible modifications and variations will be described below.

In the embodiment of FIG. 1, a GPS receiver 11 is used for obtaining position information. As already mentioned, in other embodiments position information may be obtained in other ways, for example through information received from base stations of a mobile telecommunication system, by position information received from a unit external to the mobile electronic device as for example a navigation system of a car, or through information received from satellites other than GPS satellites.

While in the embodiments described with reference to FIGS. 1 and 2 an external database is used for obtaining commercial information, i.e. information regarding businesses, a user is located at or may be interested in, in another embodiment an internal database may be used. For example, in an embodiment a database incorporated in storage 15 of the embodiment of FIG. 1 one may be used. In another embodiment, databases for specific areas may be stored e.g. on memory cards insertable into mobile device 10, such that a user may for example buy a corresponding card with a database for a desired area, for example an area the user lives in, an area the user works at or an area where the user intends to go on holidays.

It should be noted that in an embodiment, the patterns detected, the position information and the commercial information are stored solely in the mobile electronic device and is therefore not accessible for third parties, such that the privacy of the user is maintained. In another embodiment, for example with the user's consent, the information may also be transmitted to third parties, for example for improving the information provided to the user via an external or internal database.

While in the embodiment of FIG. 2 patterns are detected based on both the position information and the commercial information obtained, in another embodiments patterns may be detected based solely on the position information, and then, if for example it is detected that a user is staying for a predetermined minimum time at about the same location every day at a certain time, commercial information regarding this position may be obtained to detect for example that the user spends this time in a restaurant. In other words, the various actions described with reference to FIG. 2 need not be performed in the order shown in FIG. 2.

Further modifications and variations are possible, and the scope of the present invention is intended to be limited only by the appended claims and equivalents thereof.

What is claimed is:

1. A mobile device, comprising:
a position detecting circuit configured to obtain position information indicative of a position of said mobile device,
an information obtaining circuit configured to obtain commercial information related to said position,
a pattern detecting circuit configured to detect patterns based on said position information and said commercial information, and
an information conveying circuit configured to convey information to a user of the mobile device based on said detected patterns.

2. The mobile device of claim 1,
wherein said position detecting circuit comprises a satellite receiver configured to receive signals from a satellite navigation system.

3. The mobile device of claim 1,
wherein said information obtaining circuit comprises a telecommunication circuit to obtain said commercial information from a remote database.

4. The mobile device of claim 1,
wherein said commercial information obtaining circuit comprises a database, said database comprising said commercial information.

5. The mobile device of claim 1,
wherein said commercial information comprises information regarding a business chosen from the group comprising a restaurant, a bar, a shopping facility, a night club, a cinema, a theater, a coffee shop and a sport facility,
wherein a distance between said business and said position is smaller than a predetermined distance.

6. The mobile device of claim 1,
wherein said pattern detecting circuit is configured to detect patterns indicating that the mobile device is regularly located at a specific type of business around specific times.

7. The mobile device of claim 1,
wherein said information conveying circuit is configured to convey information regarding the specific type of business at or near said specific time.

8. The mobile device of claim 1,
wherein at least two circuits of said position detecting circuit, information obtaining circuit, pattern detecting circuit and information conveying circuit are implemented as a common circuit.

9. The mobile device of claim 1,
wherein the mobile device is chosen from the group comprising a cellular phone, a navigation system, a personal digital assistant, a smartphone, a laptop computer and a portable music player.

10. The mobile device of claim 1,
wherein said mobile device further comprises a storage,
wherein the mobile device is configured to store at least one item chosen from the group comprising said position, said commercial information and said pattern, and to delete said stored item after a predetermined time.

11. A method, comprising:
Obtaining position information indicative of a position of a mobile device,
obtaining commercial information related to said position,
detecting at least one pattern based on said position information and said commercial information, and
conveying information to a user of the mobile device based on said detected patterns.

12. The method of claim 11,
wherein said obtaining of position information comprises receiving signals from a satellite navigation system.

13. The method of claim 11,
wherein said obtaining of commercial information comprises obtaining said commercial information from a remote database.

14. The method of claim 11,
wherein said commercial information comprises information regarding a business chosen from the group comprising a restaurant, a bar, a shopping facility, a night club, a cinema, a theater, a coffee shop and a sport facility,
wherein a distance between said business and said position is smaller than a predetermined distance.

15. The method of claim 11,
wherein said pattern detecting comprises detecting at least one pattern indicating that the mobile device is regularly located at a specific type of business around specific times.
